(19) United States
(12) Patent Application Publication
(10) Pub. No.: US 2014/0127371 A1
(43) Pub. Date: May 8, 2014

(54) BREWING DEVICE HAVING A PERFORATION MEANS FOR PRODUCING A VENTILATION OPENING IN A PORTION CAPSULE

(71) Applicant: EUGSTER/FRISMAG AG ELEKTROHAUSHAL TSGERÄTE, Amriswil (CH)

(72) Inventors: Daniel FISCHER, Romanshorn (CH); Remo SONDEREGGER, Tagerwilen (CH)

(21) Appl. No.: 14/152,478

(22) Filed: Jan. 10, 2014

Related U.S. Application Data
(63) Continuation of application No. PCT/EP2012/061844, filed on Jun. 20, 2012.

(30) Foreign Application Priority Data
Jul. 13, 2011 (DE) 10 2011 107 690.9

(51) Int. Cl. A47J 31/40

(52) U.S. Cl. CPC A47J 31/407
USPC 426/431; 99/295

(57) ABSTRACT

A brewing device has a brewing chamber for extracting and/or dissolving a substance provided in a portion capsule and the brewing chamber has a first brewing chamber element and a second brewing chamber element. The first brewing chamber element can be moved between a loading position, in which the first and second brewing chamber elements are at a distance from one another, and an extraction position, in which the first and second brewing chamber elements are moved toward one another in order to form a substantially closed brewing chamber. Each brewing chamber element has a perforation means, wherein the capsule lid can be punctured using the first perforation means and the bottom area of the portion capsule can be punctured using the second perforation means. A method for extracting and/or dissolving a substance that is provided in a portion capsule includes the portion capsule is opened on the feed side of the portion capsule and on the drain side of the portion capsule.

### CROSS REFERENCE TO RELATED APPLICATIONS

This application is a Continuation of International Application No. PCT/EP2012/061844, filed on Jun. 20, 2012, entitled BREWING DEVICE HAVING A PERFORATION MEANS FOR PRODUCING A VENTILATION OPENING IN A PORTION CAPSULE, which application is hereby incorporated by reference in its entirety.

### BACKGROUND

The present invention relates to a brewing device having a brewing chamber for extracting and/or dissolving a substance provided in a portion capsule, wherein the brewing chamber has a first brewing chamber element and a second brewing chamber element and the first brewing chamber element is movable between a loading position, in which the first and the second brewing chamber element are spaced apart from one another, and an extraction position, in which the first and the second brewing chamber element have been moved toward one another in order to form a substantially closed brewing chamber, and each brewing chamber element has in each case one perforation means, wherein the capsule cover is pierceable with the first perforation means and the base region of the portion capsule is pierceable with the second perforation means. Furthermore, the present invention relates to a method for extracting and/or dissolving a substance which is provided in a portion capsule, wherein the portion capsule is opened on its inlet side and on its outlet side.

The brewing device of the generic type and the method of the generic type are known from the prior art. However, the brewing device of the generic type and the method of the generic type have the disadvantage that an undesired crema with large bubbles occasionally arises on the espresso.

It was therefore the object of the present invention to provide a brewing device and a method which do not have the disadvantages of the prior art.

### SUMMARY

The object is achieved by way of a brewing device having a brewing chamber for extracting and/or dissolving a substance provided in a portion capsule, wherein the brewing chamber has a first brewing chamber element and a second brewing chamber element and the first brewing chamber element is movable between a loading position, in which the first and the second brewing chamber element are spaced apart from one another, and an extraction position, in which the first and the second brewing chamber element have been moved toward one another in order to form a substantially closed brewing chamber, and each brewing chamber element has in each case one perforation means, wherein the capsule cover is pierceable with the first perforation means and the base region of the portion capsule is pierceable with the second perforation means, wherein the brewing device has a third perforation means which introduces a venting opening into the portion capsule, in particular into the capsule base.

The present invention relates to a brewing device having a brewing chamber for extracting and/or dissolving a substance provided in a portion capsule. This substance may be for example coffee, tea, milk, cocoa and/or some other foodstuff. The brewing chamber has a first and a second brewing chamber element, wherein one brewing chamber element is provided preferably in a stationary manner and the second brewing chamber element is movable from a loading position, in which the two brewing chamber elements are provided in a manner spaced apart from one another, into an extraction position, in which the first and the second brewing chamber element have been moved toward one another in order to form a substantially closed brewing chamber. In the loading position, the portion capsule is introduced into the brewing device, and in the extraction position, the production of the beverage and/or foodstuff by dissolving and/or extracting the substance located in the portion capsule takes place.

According to the invention, each of these brewing chamber elements has in each case one perforation means, wherein the capsule cover is pierceable with the first perforation means, which is provided preferably on the movable brewing chamber element, and in particular the base region of the capsule is pierceable with the second perforation means, which is provided preferably on the preferably stationary brewing chamber element. As a result of the two perforations of the previously hermetically closed portion capsule, the portion capsule can be flowed through by an extraction means and/or dissolver, for example hot water.

Furthermore according to the invention, the brewing device now has a third perforation means which introduces a venting opening into the capsule base. By way of this venting opening, a gas, for example air, which is located in the portion capsule, can be pushed in a targeted manner out of the portion capsule when liquid runs in. As a result, initially no excess pressure arises in the capsule and crema with large bubbles on the espresso is prevented. However, as soon as the gas has been at least largely vented from the portion capsule, a corresponding pressure builds up in the portion capsule, said pressure being required for the formation of a crema having fine bubbles.

Preferably, the third perforation means is located in the brewing chamber element which has the perforation means for perforating the base region.

Preferably, the third perforation means is arranged above the liquid outlet through which the liquid having the extract runs into a collecting vessel.

Furthermore preferably, the second perforation means, which preferably introduces the outlet opening into the portion capsule, is provided beneath the third perforation means and preferably above the first perforation means, which preferably introduces the inlet opening(s) into the portion capsule, in particular into the cover film thereof. As a result, a portion capsule, the axis of symmetry of which is provided preferably in a substantially horizontal manner during extraction/dissolving, is vented in a targeted manner and/or an upwardly directed flow into the portion capsule arises at least partially.

A further subject of the present invention is a method for extracting and/or dissolving a substance which is provided in a perforation capsule, wherein the portion capsule is opened on its inlet side and on its outlet side, wherein the portion capsule is provided at the same time or subsequently with a separate venting opening.

The statements made for the brewing device according to the invention apply in equal measure to the method according to the invention and vice versa.

The method according to the invention, too, has the advantage that as a result of the arrangement of a venting opening, a crema having coarse bubbles is avoided.

Preferably, the inlet side, i.e. that side of the portion capsule which is subjected to the flow of the extraction means/dissolver, is the side on which the cover film is attached to the portion capsule. Furthermore preferably, the outlet side, i.e. that side of the portion capsule from which the finished beverage and/or foodstuff runs out, is the base region of the portion capsule.

Preferably, a liquid flows into the portion capsule on the inlet side of the portion capsule, and the portion capsule is vented substantially at the same time through the venting opening. In this case, the gas to be vented flows into the environment preferably through the same channel as the beverage/foodstuff to be produced.

Furthermore preferably, a pressure builds up in the portion capsule following or during venting, said pressure ensuring that the venting opening at least partially closes following venting. This ensures that the liquid flows through the opening provided for that purpose and not through the venting opening. This ensures that for example a desired crema having fine bubbles is formed on the espresso.

### BRIEF DESCRIPTION OF THE FIGURES

The invention is explained in the following text with reference to FIGS. 1 to 6. These explanations are merely by way of example and do not limit the general concept of the invention. The statements apply in equal measure to both subjects of the present invention.

FIGS. 1 to 4 show different sequences of the closing of the brewing device.

FIG. 5 shows the venting of the portion capsule.

FIG. 6 shows the flowing out of the extract.

### DETAILED DESCRIPTION

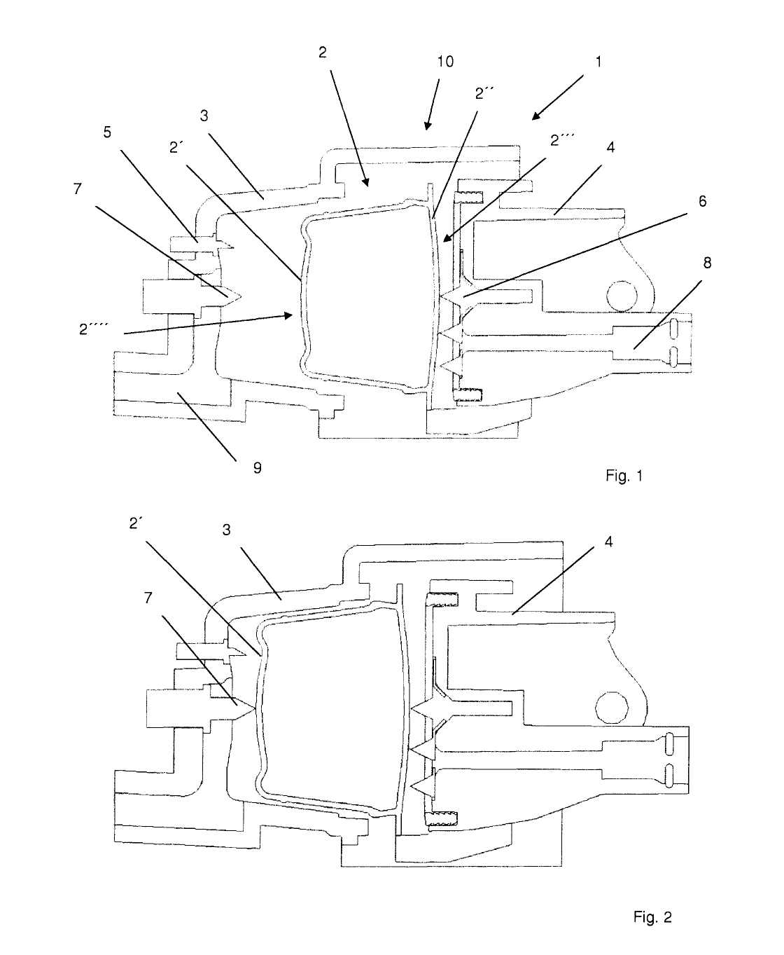

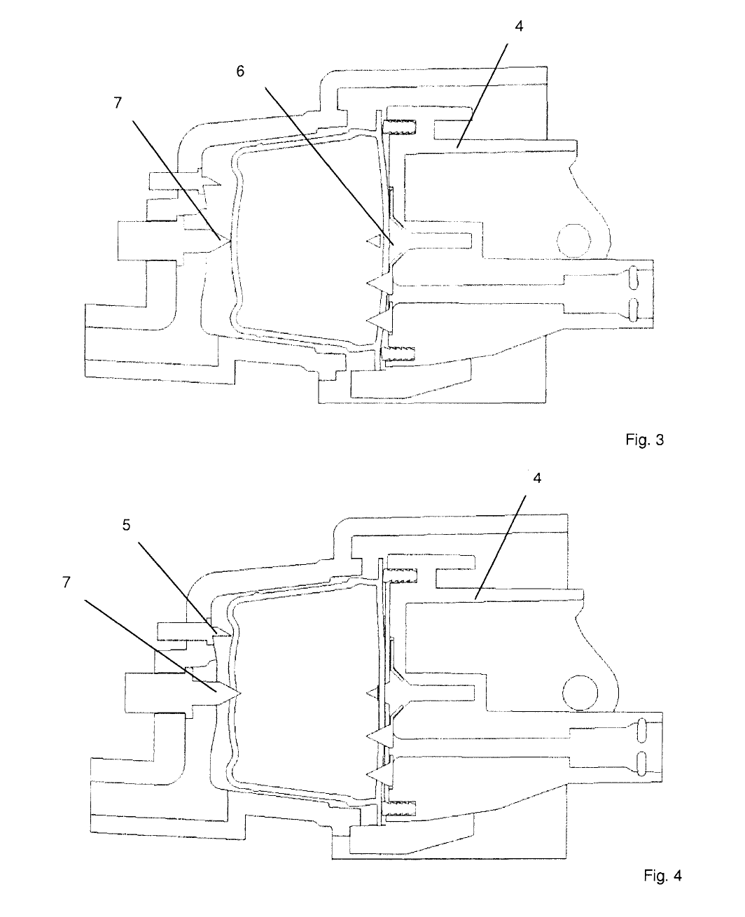

FIG. 1 shows the brewing chamber of a brewing device according to the invention for producing coffee, espresso, milk, cocoa or the like using a portion capsule (2) which has a base region (2′) and a capsule cover (2″). The substance to be extracted or dissolved is located in the hermetically closed portion capsule. The brewing chamber consists of a first, preferably stationary, brewing chamber element (3) and a second, preferably movable, brewing chamber element (4) which is transferable from a loading position (not illustrated), in which the portion capsule is introduced into the open brewing chamber, toward the left into an extraction position (cf. FIG. 5). The first brewing chamber element (3) has a second perforation means (7) by way of which the capsule base (2′) is pierced. Arranged on the second brewing chamber element (4) is the first perforation means (6), which in the present case is configured as a perforation plate having three spikes here. By way of this perforation means (6), the capsule cover is perforated so that an extraction means or dissolver, in particular hot water, which flows into the brewing chamber via the inlet channel (8), can pass into the portion capsule (1) and either extracts or dissolves the product there. The beverage or foodstuff produced in this way then runs past the second perforation means (7) into an outlet channel (9) and from there into a collecting vessel, for example a mug or a cup.

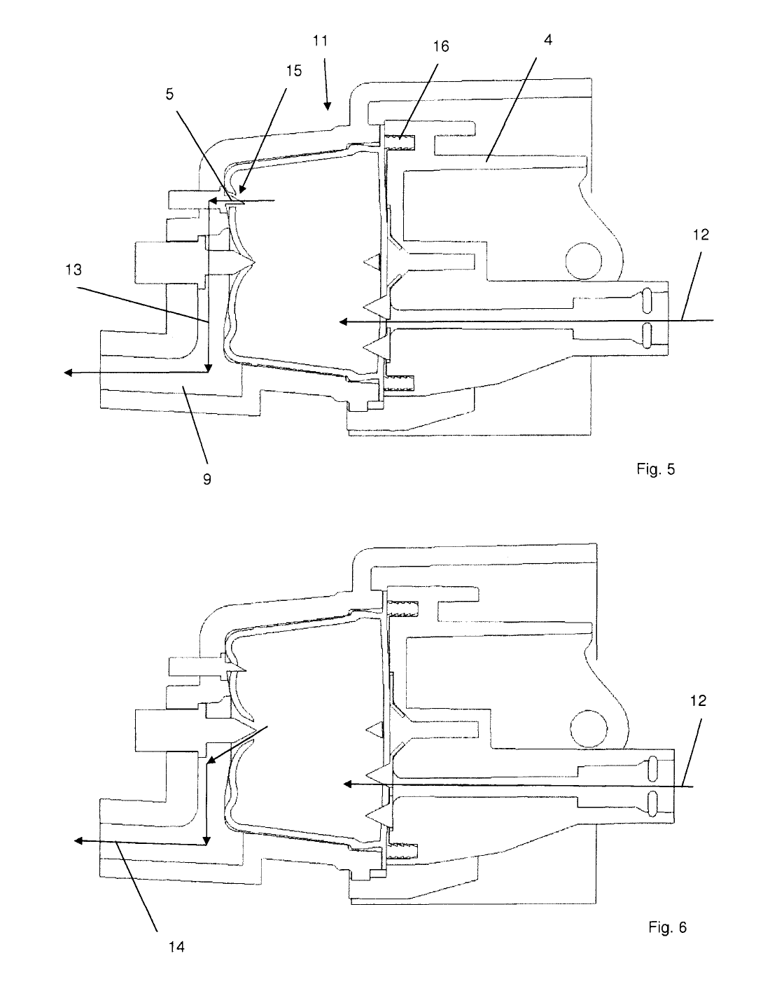

While the second brewing chamber element is being transferred from the loading position into the extraction position, the portion capsule (2) is pushed into the first brewing chamber element until the base (2′) of the portion capsule (2) bears against the second perforation means (7) (cf. FIG. 2). Upon a further movement of the second brewing chamber element (4) toward the left, the position of the portion capsule (2) remains substantially the same and the first perforation means (6) perforate the capsule cover (2″), this being illustrated in FIG. 3. Upon a further movement of the second brewing chamber element toward the left, as illustrated in FIG. 4, the second perforation means (7) perforates the capsule base (2′) and subsequently and/or at the same time the third perforation means (5) produces the venting opening (15) in the capsule base (2′). In this state, the brewing chamber is completely closed and the seal (16) seals the second brewing chamber element (4) off from the capsule cover (2″). As a result, for example hot water, which flows through the inlet channel (8), is passed into the capsule (2) and displaces from the latter, via the venting opening (15), air or some other gas from the portion capsule, said gas then passing into the environment through the outlet channel (9) (cf. FIG. 5). As a result of the venting of the portion capsule (2), no significant pressure can build up at the start of pumping and when the liquid (12) flows into the portion capsule, and so a crema having coarse bubbles cannot occur. Only when the portion capsule (2) has been at least largely vented does a significant buildup of pressure in the portion capsule take place. As a result of this buildup of pressure in the portion capsule, the venting opening (15) is at least largely closed again and the extract and/or the finished beverage is passed via the liquid outlet into the collecting vessel (cf. FIG. 6). This beverage has a crema having very fine bubbles.

1. A brewing device having a brewing chamber for extracting and/or dissolving a substance provided in a portion capsule, wherein the brewing chamber has a first brewing chamber element and a second brewing chamber element and the first brewing chamber element is movable between a loading position, in which the first and the second brewing chamber element are spaced apart from one another, and an extraction position, in which the first and the second brewing chamber element have been moved toward one another in order to form a substantially closed brewing chamber, and each brewing chamber element has in each case one perforation means, wherein the capsule cover is pierceable with the first perforation means and the base region of the portion capsule is pierceable with the second perforation means, characterized in that the brewing device has a third perforation means which introduces a venting opening into the portion capsule, in particular into the capsule base, wherein, when the portion capsule has been at least largely vented, a significant buildup of pressure takes place in the portion capsule and as a result of this buildup of pressure in the portion capsule, the venting opening is at least partially closed again.

2. The brewing device as claimed in claim 1, characterized in that it has a liquid inlet and in that the third perforation means is arranged above the liquid inlet.

3. The brewing device as claimed in claim 1, characterized in that the second perforation means is provided beneath the third perforation means.

4. A method for extracting and/or dissolving a substance which is provided in a portion capsule, wherein the portion capsule is opened on its inlet side and on its outlet side, characterized in that it is provided at the same time or subsequently with a separate venting opening.

5. The method as claimed in claim 4, characterized in that a liquid flows into the portion capsule on the inlet side of the portion capsule and the portion capsule is vented substantially at the same time through the venting opening.

6. The method as claimed in claim 5, characterized in that following or during venting, the pressure in the portion capsule rises and as a result at least partially closes the venting opening.

7. The brewing device as claimed in claim 3, characterized in that the second perforation means is provided above the first perforation means.
